(19) United States
(12) Patent Application Publication
(10) Pub. No.: US 2015/0213332 A1
(43) Pub. Date: Jul. 30, 2015

(54) IMAGE PROCESSING APPARATUS, NON-TRANSITORY COMPUTER READABLE MEDIUM, AND IMAGE PROCESSING METHOD

(71) Applicant: FUJI XEROX CO., LTD., Tokyo (JP)

(72) Inventor: Kumi FUJIWARA, Kanagawa (JP)

(73) Assignee: FUJI XEROX CO., LTD., Tokyo (JP)

(21) Appl. No.: 14/683,237

(22) Filed: Apr. 10, 2015

Related U.S. Application Data
(63) Continuation of application No. PCT/JP2013/067071, filed on Jun. 21, 2013.

(51) Int. Cl. G06K 9/68; G06K 9/62

(52) U.S. Cl. CPC G06K 9/68; G06K 9/629

(57) ABSTRACT

An image processing apparatus includes a character recognizing unit that performs character recognition on a first image and on a second image, a comparing unit that compares a first character recognition result of the first image obtained by the character recognizing unit, with a second character recognition result of the second image obtained by the character recognizing unit, a determining unit that extracts matching characters between the two character recognition results, and determines whether a character existing between the matching characters, which is obtained as either the first or second character recognition result, is one of a character deleted from the first image, an inserted character that does not exist in the first image but exists in the second image, and a character by which a character in the first image has been replaced, and an outputting unit that outputs a comparison result obtained by the comparing unit.

### CROSS-REFERENCE TO RELATED APPLICATIONS

This application is based on and claims priority under 35 USC 119 from PCT International Application No. PCT/JP2013/067071 filed Jun. 21, 2013.

### BACKGROUND

1. Technical Field

The present invention relates to an image processing apparatus, a non-transitory computer readable medium, and an image processing method.

2. Summary

According to an aspect of the invention, there is provided an image processing apparatus including a character recognizing unit that performs character recognition on a first image, and performs character recognition on a second image related to the first image, a comparing unit that compares a first character recognition result of the first image obtained by the character recognizing unit, with a second character recognition result of the second image obtained by the character recognizing unit, a determining unit that extracts matching characters between the two character recognition results, and determines whether a character existing between the matching characters, which is obtained either as the first character recognition result or as the second character recognition result, is one of a character deleted from the first image, an inserted character that does not exist in the first image but exists in the second image, and a character by which a character in the first image has been replaced, and an outputting unit that outputs a comparison result obtained by the comparing unit.

### BRIEF DESCRIPTION OF THE DRAWINGS

Exemplary embodiments of the present invention will be described in detail based on the following figures, wherein:

FIG. 1 is a conceptual module diagram of an example of configuration according to Exemplary Embodiment 1;

FIG. 2 is a flowchart illustrating an example of processing according to Exemplary Embodiment 1;

FIG. 3 illustrates an example of a character string comparison process;

FIG. 4 illustrates an example of processing according to Exemplary Embodiment 1;

FIG. 5 is a conceptual module diagram of an example of configuration according to Exemplary Embodiment 2-1;

FIG. 6 is a flowchart illustrating an example of processing according to Exemplary Embodiment 2-1;

FIG. 7 illustrates an example of processing according to Exemplary Embodiment 2-1;

FIG. 8 illustrates an example of processing according to Exemplary Embodiment 2-1;

FIG. 9 is a conceptual module diagram of an example of configuration according to Exemplary Embodiment 2-2;

FIG. 10 is a flowchart illustrating an example of processing according to Exemplary Embodiment 2-2;

FIG. 11 illustrates an example of processing according to Exemplary Embodiment 2-2;

FIGS. 12A to 12C illustrate an example of processing according to Exemplary Embodiment 2-2;

FIG. 13 illustrates an example of processing according to Exemplary Embodiment 2-2;

FIGS. 14A and 14B each illustrate an example of processing according to Exemplary Embodiment 2-2;

FIG. 15 is a conceptual module diagram of an example of configuration according to Exemplary Embodiment 2-3;

FIGS. 16A to 16I illustrate an example of processing according to Exemplary Embodiment 2-3;

FIG. 17 is a flowchart illustrating an example of processing according to Exemplary Embodiment 2-3;

FIGS. 18A to 18D illustrate an example of processing according to Exemplary Embodiment 2-3;

FIGS. 19A to 19D illustrate an example of processing according to Exemplary Embodiment 2-3;

FIG. 20 is a conceptual module diagram of an example of configuration according to Exemplary Embodiment 2-4;

FIG. 21 illustrates an example of a character image of interest according to Exemplary Embodiment 2-4;

FIG. 22 is a flowchart illustrating an example of processing according to Exemplary Embodiment 2-4;

FIGS. 23A to 23D illustrate an example of processing according to Exemplary Embodiment 2-4;

FIGS. 24A to 24D illustrate an example of processing according to Exemplary Embodiment 2-4;

FIG. 25 is a conceptual module diagram of an example of configuration according to Exemplary Embodiment 2-5;

FIG. 26 is a flowchart illustrating an example of processing according to Exemplary Embodiment 2-5;

FIG. 27 is a conceptual module diagram of an example of configuration according to Exemplary Embodiment 2-6;

FIG. 28 is a flowchart illustrating an example of processing according to Exemplary Embodiment 2-6; and

FIG. 29 is a block diagram illustrating an example of the hardware configuration of a computer for implementing the exemplary embodiments.

### DETAILED DESCRIPTION

Hereinafter, various exemplary embodiments of the present invention will be described with reference to the drawings.

### Exemplary Embodiment 1

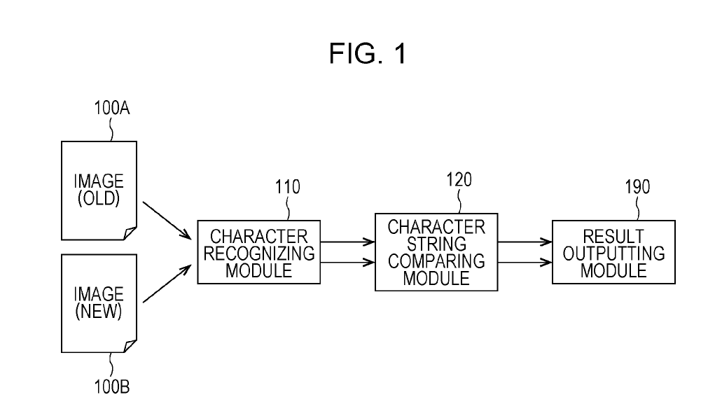

FIG. 1 is a conceptual module diagram of an example of configuration according to Exemplary Embodiment 1.

The term “module” generally refers to a logically separable component of software (computer program), hardware, or the like. Therefore, the term “module” as used in the exemplary embodiments refers to not only a module in a computer program but also a module in a hardware configuration. Thus, the exemplary embodiments will be also described in the context of a computer program for providing functions of modules (a program for causing a computer to execute individual procedures, a program for causing a computer to function as individual units, and a program for causing a computer to realize individual functions), a system, and a method. While “store”, “be stored”, and equivalent expressions are used herein for the convenience of description, these expressions mean, when an exemplary embodiment relates to a computer program, “cause a memory to store” or “perform control so as to cause a memory to store.” While individual modules and functions may have a one-to-one correspondence, in actual implementation, a single module may be implemented by a single program, or multiple modules may be implemented by a single program. Conversely, a single module may be implemented by multiple programs. Further, multiple modules may be executed by a single computer, or a single module may be executed by multiple computers that are in a distributed or parallel environment. A single module may include another module. In the following description, the term “connection” refers to not only a physical connection but also a logical connection (such as exchanging of data, issuing of an instruction, and cross-reference between data items). The term “predetermined” as used herein means being determined prior to a process of interest, which not only means being determined before processing according to the exemplary embodiments begins but also being determined, even after the processing according to the exemplary embodiments begins, at any point in time preceding a process of interest in accordance with the condition/state at that point in time, or in accordance with the condition/state up to that point in time. If multiple “predetermined values” exist, each of these values may be different, or two or more of these values may be the same (which includes, of course, cases where all of these values are the same). Further, expressions that have the meaning of “if A, then B” is used to mean that “it is determined whether A, and then B if it is determined that A”, unless it is not necessary to determine whether A.

Furthermore, the term “system” or “apparatus” includes not only cases where a system or apparatus is made up of multiple computers, hardware components, devices, or the like that are connected to each other via a communication medium such as a network (including a one-to-one communication setup), but also cases where a system or apparatus is implemented by a single computer, hardware component, or device. The terms “apparatus” and “system” are herein used synonymously. As a matter of course, the term “system” does not include what is merely a social “mechanism” (social system) which is a man-made arrangement of rules.

Further, for each process executed by each module or, if multiple processes are to be executed within a module, for each of the multiple processes, information of interest is read from a memory, and after execution of the corresponding process, the results of processing are written into the memory. Therefore, a description about reading of information from a memory prior to a process, or writing of information into a memory after a process will sometimes be omitted. The term “memory” as used herein may include a hard disk, a random access memory (RAM), an external storage medium, a memory using a communication line, and a register in a central processing unit (CPU).

An image processing apparatus according to Exemplary Embodiment 1 compares multiple images. As illustrated in FIG. 1, the image processing apparatus has a character recognizing module 110, a character string comparing module 120, and a result outputting module 190.

The character recognizing module 110 is connected to the character string comparing module 120. The character recognizing module 110 performs character recognition on an image (old) 100A, and performs character recognition on an image (new) 100B related to the image (old) 100A. For example, the image (old) 100A corresponds to a document image before modification. The image (new) 100B corresponds to a document image after modification. As for the relationship between the image (old) 100A and the image (new) 100B, these images need only to be images to be compared, and may not necessarily be images before and after modification. An image to be accepted may be accepted by, for example, reading an image by a scanner, a camera, or the like, receiving an image from an external apparatus by faxing or the like via a communication line, or reading an image stored in a hard disk (including, for example, a hard disk connected via a network, in addition to a hard disk built in a computer). An image may be a binary image or a multi-valued image (including a color image). There may be two or more images to be accepted (images to be compared). Further, as for the content of an image, as long as characters subject to character recognition are included, the image may be a document used for business, a brochure used for advertisement, or the like.

The character string comparing module 120 is connected to the character recognizing module 110 and the result outputting module 190. The character string comparing module 120 compares a first character recognition result of the image (old) 100A obtained by the character recognizing module 110, with a second character recognition result of the image (new) 100B obtained by the character recognizing module 110. Then, through the comparison process, characters that match between the two character recognition results are extracted, and the character recognition results are classified into “matching characters” and “characters that are not matching characters.” Then, the “characters that are not matching characters” are each classified into one of a deleted character, an inserted character, and a replaced character. That is, it is determined whether each of characters obtained as the first character recognition result or the second character recognition result is a character deleted from the image (old) 100A, a character inserted into image (new) 100B, or a character representing replacement of a character in the image (old) 100A by another character in the image (new) 100B. Specifically, the character string comparing module 120 makes comparisons by text code. Correspondences among characters that match (to be also referred to as matching characters) are made on a character-by-character basis. A character sandwiched between matching characters is either a character that has been deleted (to be also referred to as deleted character), a character that has been inserted (to be also referred to as inserted character), or a character that has been replaced (to be also referred to as replaced character). Correspondences among replaced characters are also made on a character-by-character basis. As the editing mode, a case in which a character is determined to be a matching character is referred to as “Match”, a case in which a character is determined to be a deleted character is referred to as “Delete”, a case in which a character is determined to be an inserted character is referred to as “Insert”, and a case in which a character is determined to be a replaced character is referred to as “Replace.” Character types may not necessarily be limited to a matching character, a deleted character, an inserted character, and a replaced character. For example, character types may include only a matching character and a non-matching character. Since a replaced character is a combination of a deleted character and an inserted character, character types may include only a matching character, a deleted character, and an inserted character.

The result outputting module 190 is connected to the character string comparing module 120. The result outputting module 190 outputs the result of comparison made by the character string comparing module 120. The comparison result may be output as an image or as text. Non-matching characters may be highlighted (by, for example, changing their color) to make the non-matching characters more noticeable in contrast to matching characters, or only non-matching characters may be output. For example, character images whose colors are varied to distinguish matching characters, deleted characters, and replaced characters from one another may be displayed while being superimposed on the image (old) 100A. Further, character images whose colors are varied to distinguish matching characters, deleted characters, and replaced characters from one another may be displayed while being superimposed on the image (new) 100B.

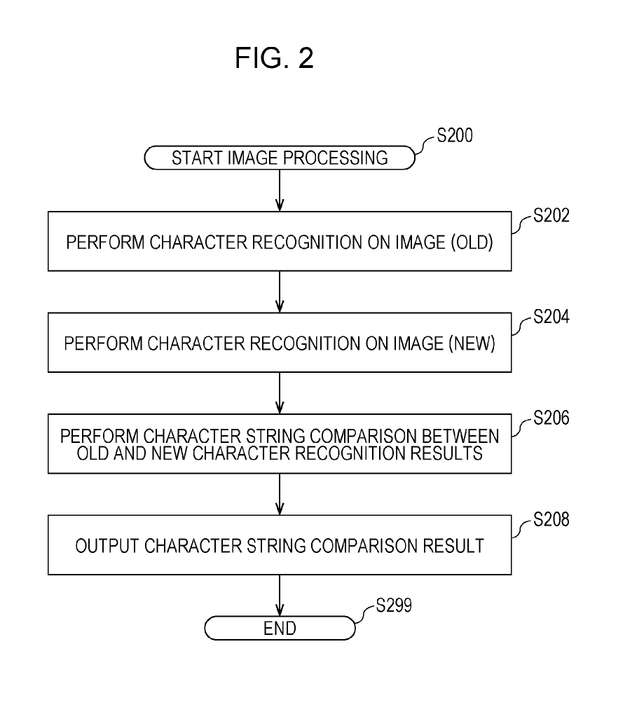

FIG. 2 is a flowchart illustrating an example of processing according to Exemplary Embodiment 1.

In step S202, the character recognizing module 110 performs character recognition on the image (old) 100A.

In step S204, the character recognizing module 110 performs character recognition on the image (new) 100B.

In step S206, the character string comparing module 120 performs a character string comparison between the old and new character recognition results.

In step S208, the result outputting module 190 outputs the character string comparison result.

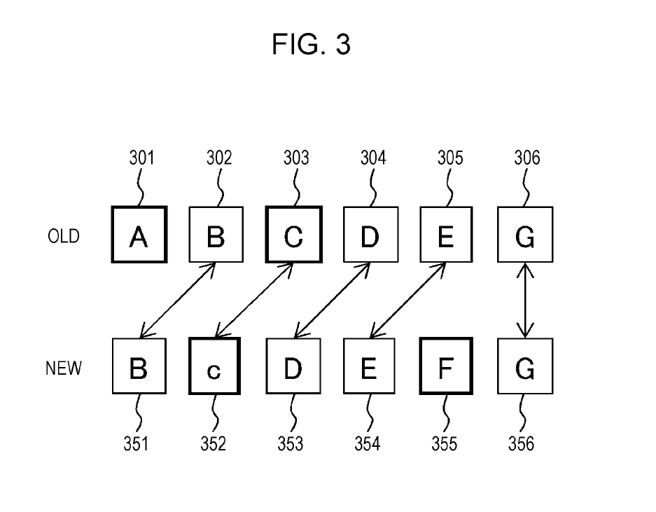

FIG. 3 illustrates an example of a character string comparison process.

FIG. 3 illustrates a case in which a comparison is made between “ABCDEG”, which is a portion of the character recognition result of the image (old) 100A, and “BcDEFG” which is a portion of the character recognition result of the image (new) 100B. It is apparent from the correspondences of “B” and “D” that “C” and “c” correspond to each other. That is, a recognized character C: 303 (sandwiched between a recognized character B: 302 and a recognized character D: 304) and a recognized character c: 352 (sandwiched between a recognized character B: 351 and a recognized character D: 353), which are characters sandwiched between a pair of the recognized character B: 302 and the recognized character B: 351 that are matching characters and a pair of the recognized character D: 304 and the recognized character D: 353 that are matching characters, correspond to each other, and the recognized character C: 303 and the recognized character c: 352 are replaced characters. Replaced characters may have, other than a one-to-one relationship, an N-to-M relationship (N and M are integers not smaller than one). For example, when a single character is replaced by two characters, these characters are likewise regarded as replaced characters.

Further, a recognized character A: 301 exists in the character recognition result of the image (old) 100A but does not exists in the character recognition result of the image (new) 100B. Therefore, the recognized character A: 301 is a deleted character. A recognized character F: 355 does not exist in the character recognition result of the image (old) 100A but exits in the character recognition result of the image (new) 100B. Therefore, the recognized character F: 355 is an inserted character.

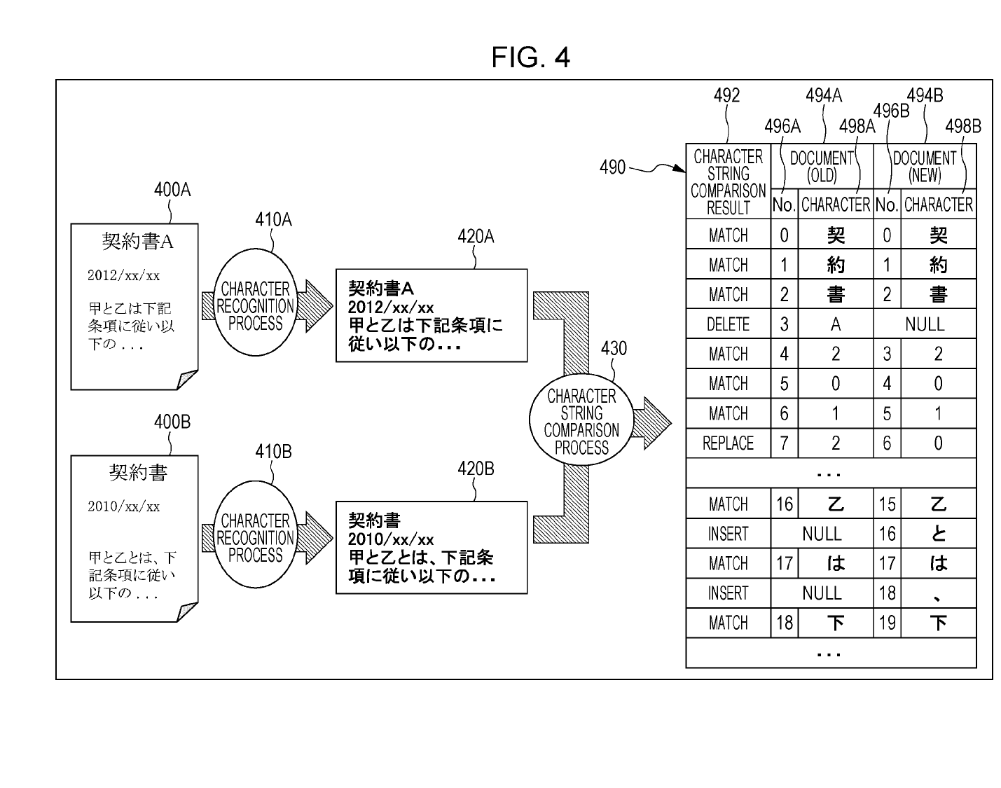

FIG. 4 illustrates an example of processing according to Exemplary Embodiment 1.

The character recognizing module 110 performs a character recognition process 410A on an image (old) 400A, and passes a character recognition result 420A to the character string comparing module 120. The character recognizing module 110 performs a character recognition process 410B on an image (new) 400B, and passes a character recognition result 420B to the character string comparing module 120. Either one of the character recognition processes 410A and 410B may be performed earlier than the other, or the character recognition processes 410A and 410B may be performed in parallel.

Then, the character string comparing module 120 performs a character string comparison process 430 on the character recognition result 420A and the character recognition result 420B, and passes a comparison result table 490 to the result outputting module 190.

The comparison result table 490 has a character string comparison result field 492, a document (old) field 494A, and a document (new) field 494B. The document (old) field 494A has a No. field 496A and a character field 498A. The document (new) field 494B has a No. field 496B and a character field 498B. “A” (the character at position No. 3 in the document (old) field 494A) is a deleted character. “2” (the character at position No. 7 in the document (old) field 494A) and “0” (the character at position No. 6 in the document (new) field 494B) are replaced characters. “ [symbol] ” (the character at position No. 16 in the document (new) field 494B) is an inserted character. “'” (the character at position No. 18 in the document (new) field 494B) is an inserted character.

### Exemplary Embodiment 2-1

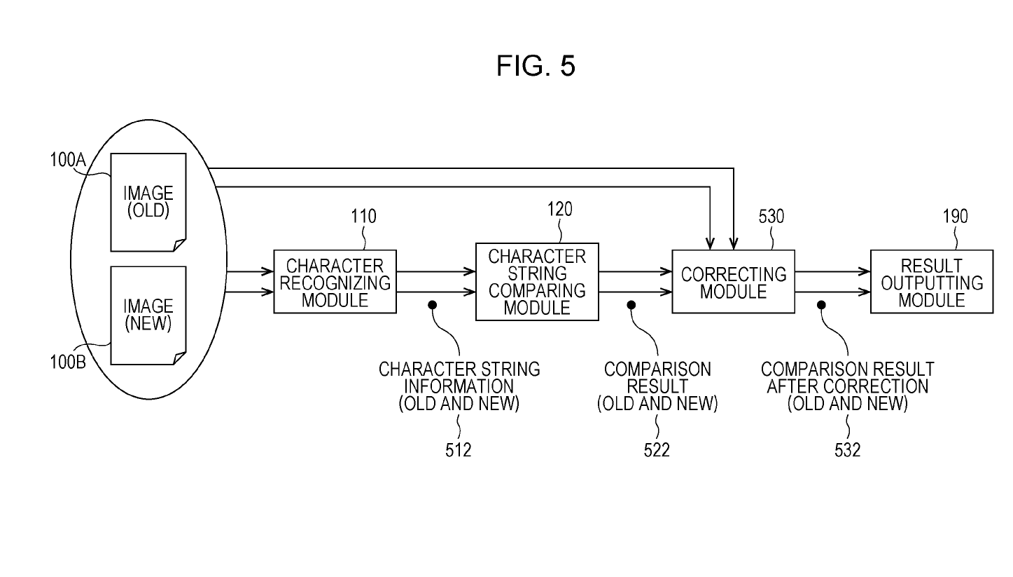

FIG. 5 is a conceptual module diagram of an example of configuration according to Exemplary Embodiment 2-1.

Portions that are identical to those of the above-mentioned exemplary embodiment are denoted by the same reference signs and any repetitive description of these portions is omitted herein (the same applies hereinafter). As compared with the processing according to Exemplary Embodiment 1, Exemplary Embodiment 2 has an additional process of correcting the processing result obtained by the character string comparing module 120 by using the image (old) 100A and the image (new) 100B, and as illustrated in the example of FIG. 5, the character recognizing module 110, the character string comparing module 120, a correcting module 530, and the result outputting module 190 are provided.

The character recognizing module 110 is connected to the character string comparing module 120. The character recognizing module 110 passes character string information 512 including the respective character recognition results of the image (old) 100A and the image (new) 100B to the character string comparing module 120.

The character string comparing module 120 is connected to the character recognizing module 110 and the correcting module 530.

The correcting module 530 is connected to the character string comparing module 120 and the result outputting module 190. The correcting module 530 corrects a comparison result 522 obtained by the character string comparing module 120, by comparing corresponding character images in the image (old) 100A and the image (new) 100B.

The result outputting module 190 is connected to the correcting module 530. The result outputting module 190 outputs a comparison result 532 that has been corrected by the correcting module 530.

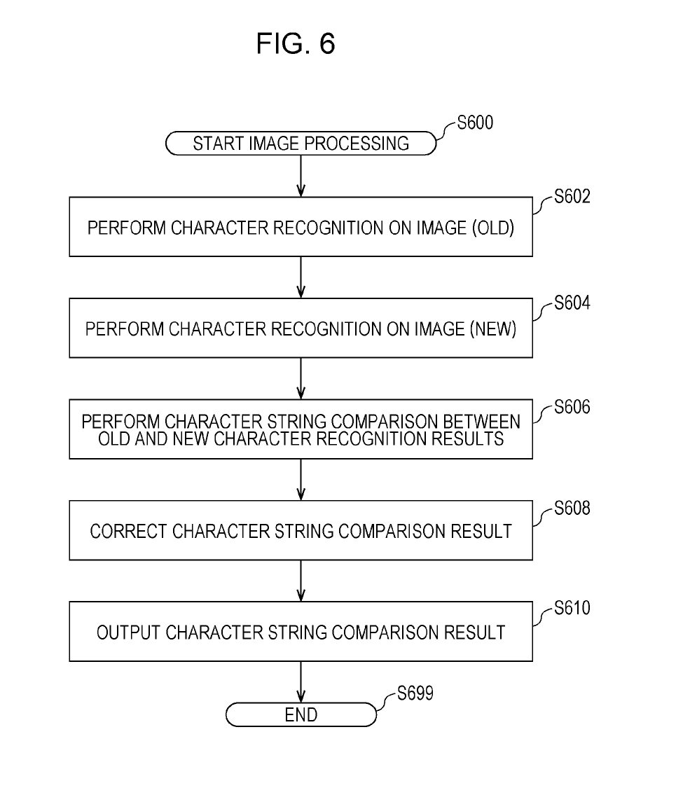

FIG. 6 is a flowchart illustrating an example of processing according to Exemplary Embodiment 2-1.

In step S602, the character recognizing module 110 performs character recognition on the image (old) 100A.

In step S604, the character recognizing module 110 performs character recognition on the image (new) 100B.

In step S606, the character string comparing module 120 performs a character string comparison between the old and new character recognition results.

In step S608, the correcting module 530 corrects the character string comparison result.

In step S610, the result outputting module 190 outputs the character string comparison result.

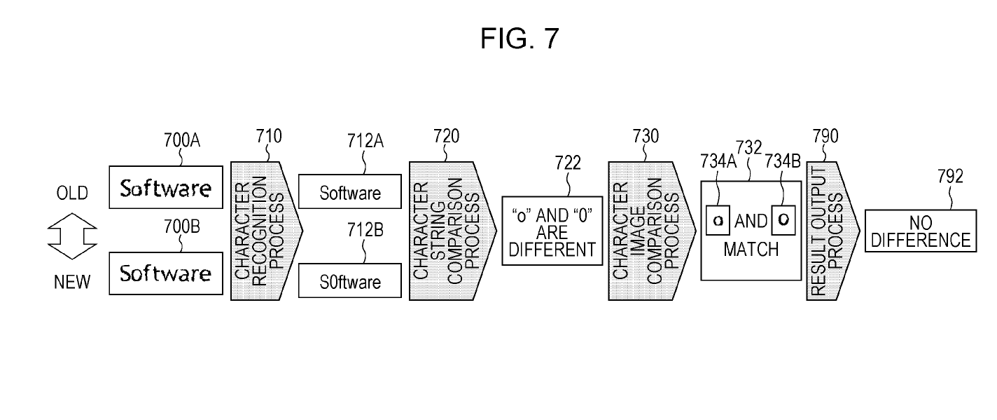

FIG. 7 illustrates an example of processing according to Exemplary Embodiment 2-1.

The character recognizing module 110 performs a character recognition process 710 on a character image of interest (old) 700A and a character image of interest (new) 700B. As a result, a character recognition result (old) 712A “Software” is obtained for the character image of interest (old) 700A, and a character recognition result (new) 712B “S0ftware” is obtained for the character image of interest (new) 700B.

The character string comparing module 120 performs a character string comparison process 720 on the character recognition result (old) 712A and the character recognition result (new) 712B. As a result, a character string comparison result 722 is obtained which indicates that the second characters “o” and “0” of the character recognition result (old) 712A and the character recognition result (new) 712B are different. At this time, the editing mode is set to “Replace” for the different characters.

The correcting module 530 compares the character images (a character image (old) 734A and a character image (new) 734B) of the second characters of the character image of interest (old) 700A and the character image of interest (new) 700B, which are indicated by the character string comparison result 722 as being different, and outputs a character image comparison result 732 indicating that the two character images match.

Now, the editing mode is modified from “Replace” to “Match.” Then, the result outputting module 190 outputs a result 792 indicating that “there is no difference between the character image of interest (old) 700A and the character image of interest (new) 700B.” The editing mode for the character recognition results becomes “Match.”

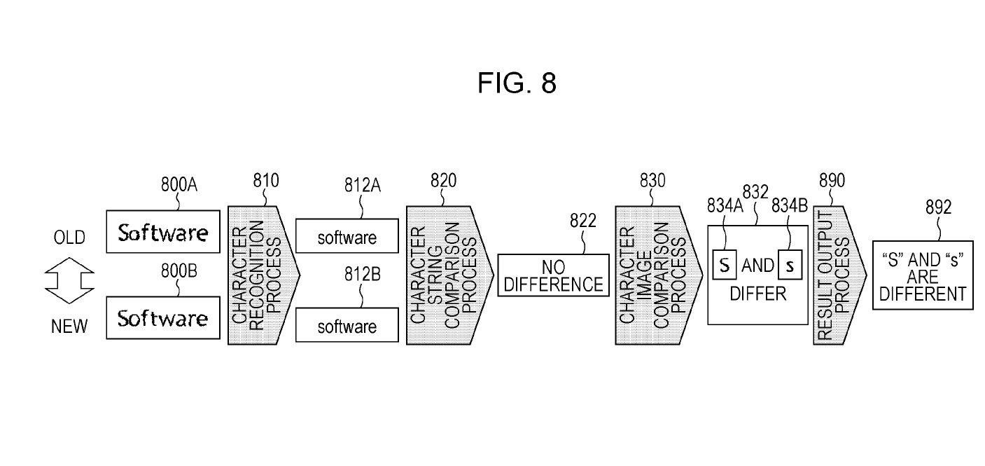

FIG. 8 illustrates an example of processing according to Exemplary Embodiment 2-1.

The character recognizing module 110 performs a character recognition process 810 on a character image of interest (old) 800A and a character image of interest (new) 800B. As a result, a character recognition result (old) 812A “software” is obtained for the character image of interest (old) 800A, and a character recognition result (new) 812B “software” is obtained for the character image of interest (new) 800B.

The character string comparing module 120 performs a character string comparison process 820 on the character recognition result (old) 812A and the character recognition result (new) 812B. As a result, a character string comparison result 822 is obtained which indicates that there is no difference. At this time, the editing mode is set to “Match” for the character strings (individual characters) being compared.

The correcting module 530 compares the character images (a character image (old) 834A and a character image (new) 834B) of the respective first characters in the character image of interest (old) 800A and the character image of interest (new) 800B, which are indicated by the character string comparison result 822 as having no difference, and outputs a character image comparison result 832 indicating that the two character images differ.

Now, the editing mode is modified from “Match” to “Replace.” Then, the result outputting module 190 outputs a result 892 indicating that “the character images of the first characters in the character image of interest (old) 800A and the character image of interest (new) 800B are different.” The editing mode for “S” and “s” obtained as a result of character recognition becomes “Replace.” At this time, the correct character code remains unknown. Specifically, it remains unknown whether the first character of the character image of interest (old) 800A is not “S”, or the first character of the character image of interest (new) 800B is not “S.”

### Exemplary Embodiment 2-2

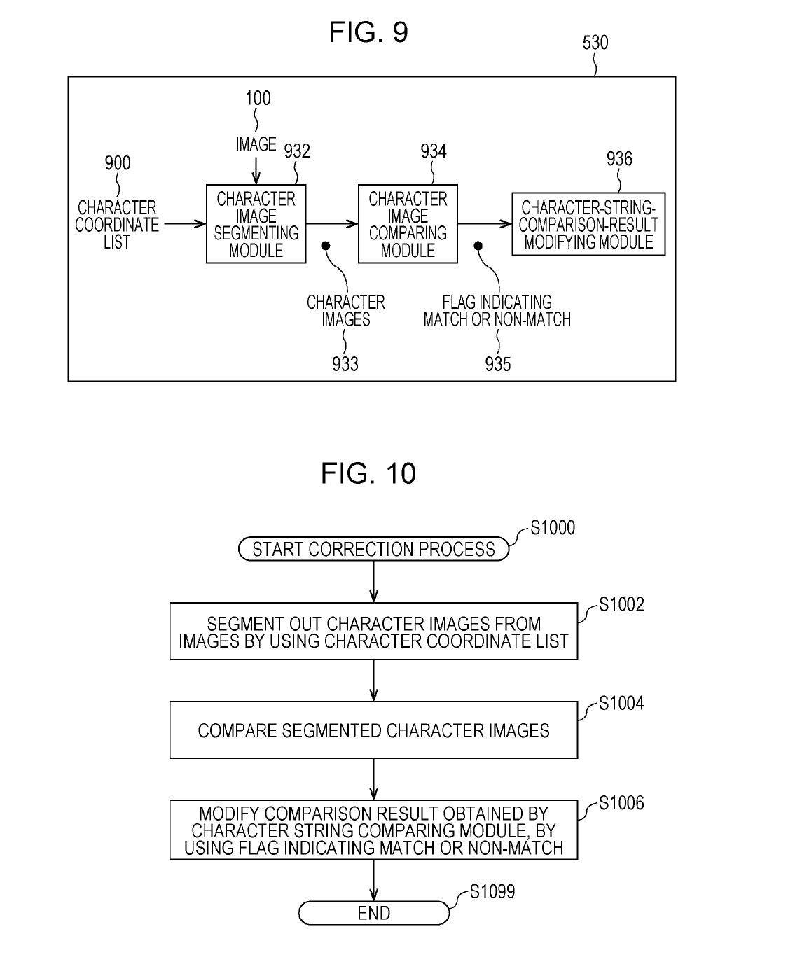

FIG. 9 is a conceptual module diagram of an example of configuration according to Exemplary Embodiment 2-2. Exemplary Embodiment 2-2 represents a detailed configuration of modules within the correcting module 530 according to Exemplary Embodiment 2-1. The correcting module 530 has a character image segmenting module 932, a character image comparing module 934, and a character-string-comparison-result modifying module 936.

The character image segmenting module 932 is connected to the character image comparing module 934. The character image segmenting module 932 segments out character images 933 by using a character coordinate list 900 from images 100 (the image (old) 100A and the image (new) 100B). The character coordinate list 900 is output by the character recognizing module 110 together with the character recognition result.

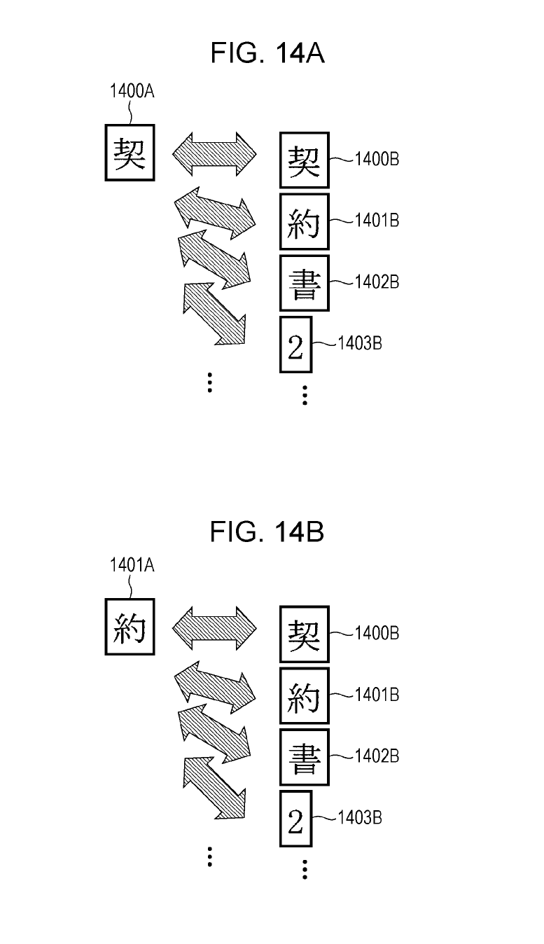

The character image comparing module 934 is connected to the character image segmenting module 932 and the character-string-comparison-result modifying module 936. The character image comparing module 934 compares the corresponding character images 933 in the image (old) 100A and the image (new) 100B. The character image comparing module 934 passes a flag indicative of match or non-match 935 as a comparison result to the character-string-comparison-result modifying module 936. Corresponding character images may mean each combination of the character images of characters that are regarded as corresponding to each other by the character string comparing module 120 (each combination of matching characters or each combination of replaced characters), combinations of all of the character images in the image (old) 100A and the image (new) 100B (combinations described in detail later with reference to FIGS. 14A and 14B), or other combinations (combinations described in detail later). The comparison process will be described in detail later with reference to Exemplary Embodiment 2-3 and Exemplary Embodiment 2-4.

The character-string-comparison-result modifying module 936 is connected to the character image comparing module 934. If a “Match” determination is made by the character image comparing module 934, the character-string-comparison-result modifying module 936 rewrites the editing mode for the corresponding characters to “Match.” If a “Not match” determination is made by the character image comparing module 934, the character-string-comparison-result modifying module 936 rewrites the editing mode for the corresponding characters to “Replace.”

FIG. 10 is a flowchart illustrating an example of processing according to Exemplary Embodiment 2-2 (in particular, the modules in the correcting module 530).

In step S1002, the character image segmenting module 932 segments out character images from both of the images 100 by using the character coordinate list 900.

In step S1004, the character image comparing module 934 compares both of the segmented character images 933.

In step S1006, the character-string-comparison-result modifying module 936 modifies the comparison result 522 obtained by the character string comparing module 120, by using the flag indicative of match or non-match 935.

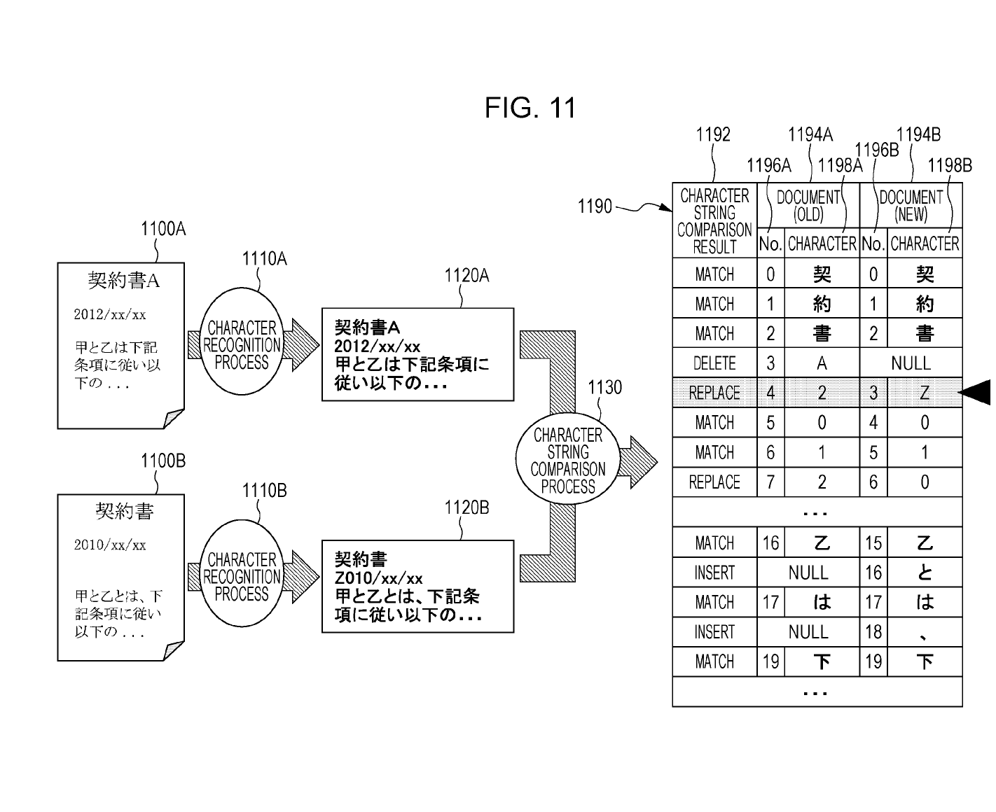

FIG. 11 illustrates an example of processing according to Exemplary Embodiment 2-2.

The character recognizing module 110 performs a character recognition process 1110A on a document (old) 1100A, and passes a character recognition result 1120A to the character string comparing module 120. The character recognizing module 110 performs a character recognition process 1110B on a document (new) 1100B, and passes a character recognition result 1120B to the character string comparing module 120. Either one of the character recognition processes 1110A and 1110B may be performed earlier than the other, or the character recognition processes 1110A and 1110B may be performed in parallel.

Then, the character string comparing module 120 performs a character string comparison process 1130 on the character recognition result 1120A and the character recognition result 1120B, and passes a comparison result table 1190 to the result outputting module 190.

The comparison result table 1190 has a character string comparison result field 1192, a document (old) field 1194A, and a document (new) field 1194B. The document (old) field 1194A has a No. field 1196A and a character field 1198A. The document (new) field 1194B has a No. field 1196B and a character field 1198B. The comparison result table 1190 is equivalent to the comparison result table 490 illustrated in the example of FIG. 4. It is to be noted, however, that the comparison result table 1190 shows the result after a correction process by the character-string-comparison-result modifying module 936.

Processing performed by the character-string-comparison-result modifying module 936 is described below. The following describes correction of the editing mode for the combination of the character “Z” (the character at position No. 3 in the document (new) field 1194B), which is an erroneously recognized character, and the character “2” (the character at position No. 4 in the document (old) field 1194A).

It is determined by comparison of character images by the character image comparing module 934 that a character at position number 4 in the document (old) 1100A and a character at position number 3 in the document (new) 1100B match. Further, it is also determined that a character at position number 7 in the document (old) 1100A and a character at position number 3 in the document (new) 1100B match.

At this time, through processing by the character-string-comparison-result modifying module 936, the matching relation with the character at position number 4 in the document (old) 1100A is adopted. This is because if it is assumed that, as a result of a character string comparison process, the character at position number 3 in the document (new) 1100B and the character at position number 4 in the document (old) 1100A correspond to each other, their two succeeding characters also match, whereas if it is assumed that the character at position number 3 in the document (new) 1100B and the character at position number 7 in the document (old) 1100A correspond to each other, their succeeding characters do not match. That is, if the comparison process by the character image comparing module 934 results in multiple characters that match a character of interest, each of these characters is assumed to match, and then the character for which there are more succeeding characters that are matching characters is determined as a corresponding character. Instead of succeeding characters, this process may be performed with respect to preceding characters, or with respect to both preceding and succeeding characters.

Since it is now determined that the character at position number 4 in the document (old) 1100A and the character at position number 3 in the document (new) 1100B match, next, the character-string-comparison-result modifying module 936 rewrites the content of the character string comparison result field 1192 for the character string comparison result of the character at position number 4 in the document (old) 1100A, and the character at position number 3 in the document (new) 1100B, from “Replace” to “Match.”

At this time, the character-string-comparison-result modifying module 936 may replace the text code “Z” by “2”, or may replace the text code “2” by “Z.” However, the character-image-comparison-result modifying module 936 makes no determination as to which one of the new and old text codes is correct. The exemplary embodiments are not directed to correction of the character recognition result.

The comparison result table 1190 is a table showing the character string comparison result. Characters arranged in the same row mean that a correspondence has been made between these characters as a result of the character string comparison process. Even for replaced characters, characters that correspond to each other may be identified from the correspondences among their preceding and succeeding matching characters as mentioned above.

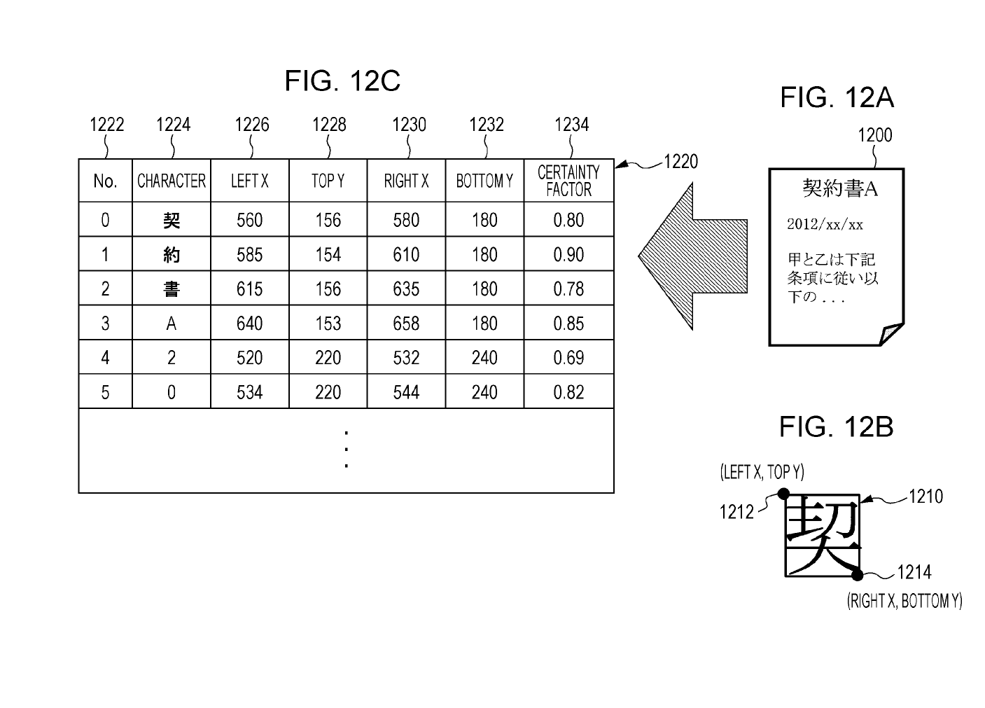

FIGS. 12A to 12C illustrate an example of processing according to Exemplary Embodiment 2-2 (with an emphasis on the processing by the character recognizing module 110 and the character image segmenting module 932).

The character recognizing module 110 outputs, together with the character recognition result, the coordinates of recognized characters. The character image segmenting module 932 segments out character images based on the coordinates. The character recognition result of an image (old) 1200 illustrated in the example of FIG. 12A and the coordinates of characters in the image (old) 1200 are as shown in a character recognition result etc. table 1220 illustrated in the example of FIG. 12C. The character recognition result etc. table 1220 has a No. field 1222, a character field 1224, a left X field 1226, a top Y field 1228, a right X field 1230, a bottom Y field 1232, and a certainty factor field 1234. The character field 1224 stores text code as a character recognition result. The left X field 1226, the top Y field 1228, the right X field 1230, and the bottom Y field 1232 store the coordinates of a character. That is, the character recognition result etc. table 1220 shows top left coordinates 1212 and bottom right coordinates 1214 of a character rectangle 1210 illustrated in the example of FIG. 12B. Of course, the combination may be that of top right and bottom left coordinates or, alternatively, the coordinates of the character rectangle 1210 may be represented by the coordinates of one of the four corners, width, and height of the character rectangle 1210. The certainty factor field 1234 stores information indicating the likelihood of the correctness of the result of character recognition by a character recognition process performed by the character recognizing module 110. For example, a higher numerical value indicates a greater likelihood that the text code in question is correct. A process using information stored in the certainty factor field 1234 will be described later.

The character image segmenting module 932 segments out character images from the image (old) 100A and the image (new) 100B by using the character recognition result etc. table 1220.

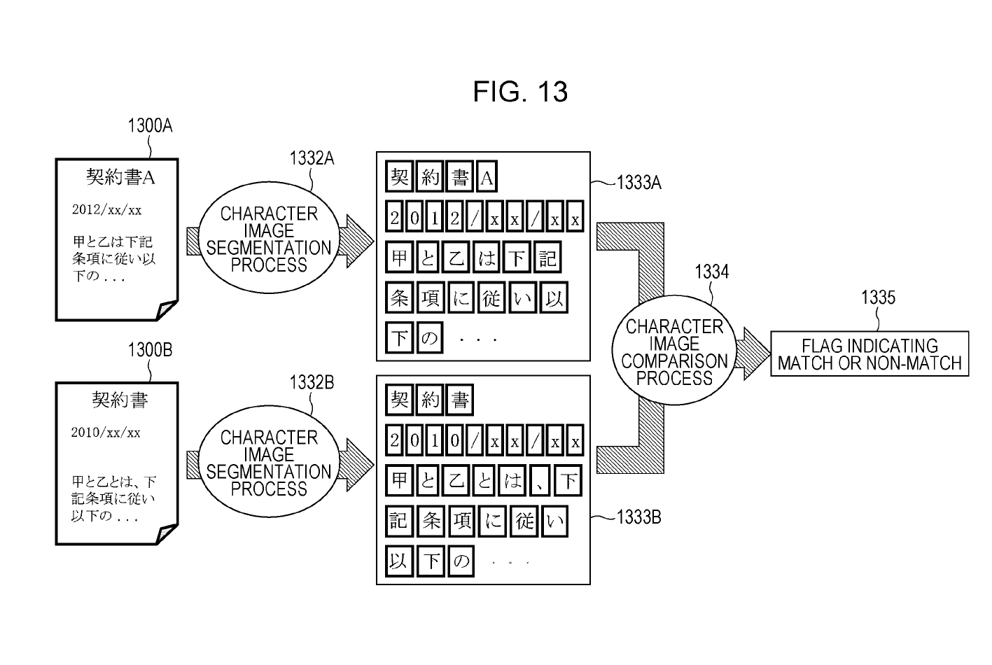

FIG. 13 illustrates an example of processing according to Exemplary Embodiment 2-2. The character image segmenting module 932 performs a character image segmentation process 1332A on an image (old) 1300A by using the character recognition result etc. table 1220, and passes a group of character images (old) 1333A to the character image comparing module 934. The character image segmenting module 932 performs a character image segmentation process 1332B on an image (new) 1300B by using the character recognition result etc. table 1220, and passes a group of character images (new) 1333B to the character image comparing module 934. The character image comparing module 934 performs a character image comparison process 1334 on the group of character images (old) 1333A and the group of character images (new) 1333B, and passes a flag indicative of match or non-match 1335 to the character-string-comparison-result modifying module 936.

In the character image comparison process 1334, comparisons may be made for all combinations of character images to be compared. As illustrated in the example of FIG. 14A, the comparison process is performed for combinations of a recognized character 1400A in the group of character images (old) 1333A and each of character images (recognized characters 1400B, 1401B, 1402B, 1403B, and so on) in the group of character images (new) 1333B, and then, as illustrated in the example of FIG. 14B, the comparison process is performed for combinations of a recognized character 1401A in the group of character images (old) 1333A and each of character images (the recognized characters 1400B, 1401B, 1402B, 1403B, and so on) in the group of character images (new) 1333B.

### Exemplary Embodiment 2-3

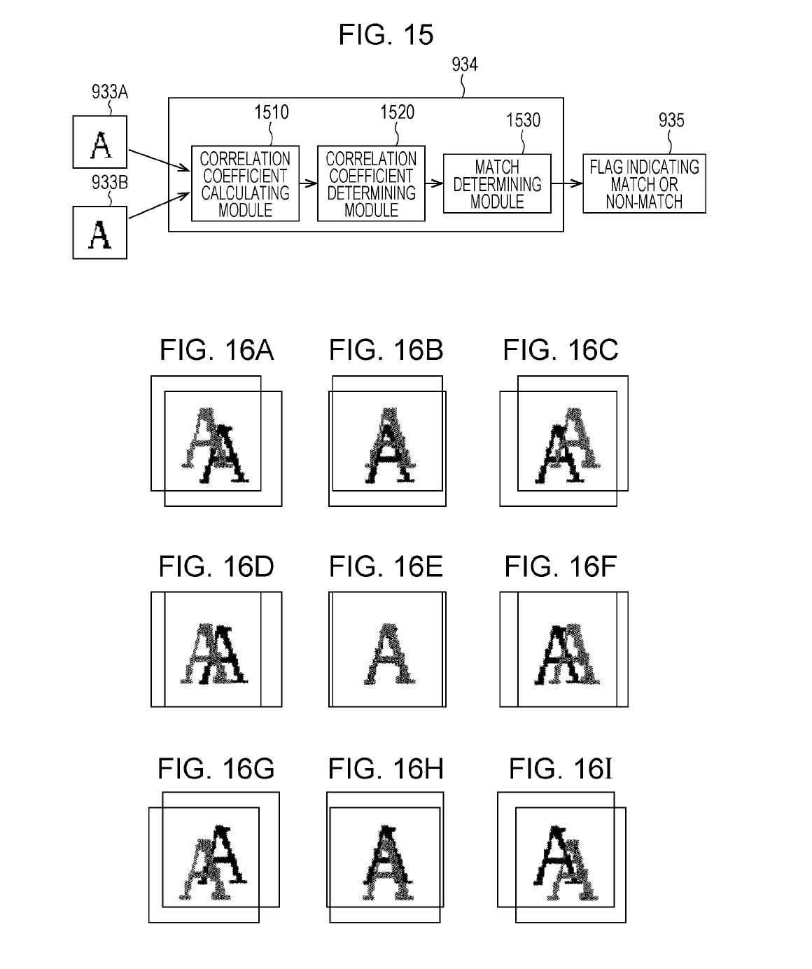

FIG. 15 is a conceptual module diagram of an example of configuration according to Exemplary Embodiment 2-3. Exemplary Embodiment 2-3 represents a detailed configuration of modules within the character image comparing module 934 according to Exemplary Embodiment 2-2. The character image comparing module 934 has a correlation coefficient calculating module 1510, a correlation coefficient determining module 1520, and a match determining module 1530.

The correlation coefficient calculating module 1510 is connected to the correlation coefficient determining module 1520. The correlation coefficient calculating module 1510 calculates the correlation coefficient between a character image (old) 933A in the image (old) 100A and a character image (new) 933B in the image (new) 100B. For example, the correlation is calculated by gradually shifting the character image (new) 933B relative to the character image (old) 933A. Specifically, as illustrated in the example of FIGS. 16A to 16I, the two character images are laid over each other while being gradually shifted relative to each other, and their correlation in terms of brightness is calculated. More specifically, an exclusive-or (FOR) process is performed on the two character images, the remaining pixel values are counted, and the inverse of the counted value is taken as the correlation value.

The correlation coefficient determining module 1520 is connected to the correlation coefficient calculating module 1510 and the match determining module 1530. The correlation coefficient determining module 1520 determines the amount of difference at the location of the highest correlation as the correlation coefficient for this candidate character. This corresponds to FIG. 16E.

The match determining module 1530 is connected to the correlation coefficient determining module 1520. The match determining module 1530 compares the correlation coefficient passed from the correlation coefficient determining module 1520 with a predetermined threshold, and determines that the character image (old) 933A and the character image (new) 933B match if “the correlation coefficient is greater than, or greater than or equal to, the threshold.” The character images are determined to be different if “the correlation coefficient is less than or equal to, or less than, the threshold.”

Thereafter, the character-string-comparison-result modifying module 936 corrects a comparison result obtained by the character string comparing module 120, by using the flag indicative of match or non-match 935 passed from the match determining module 1530.

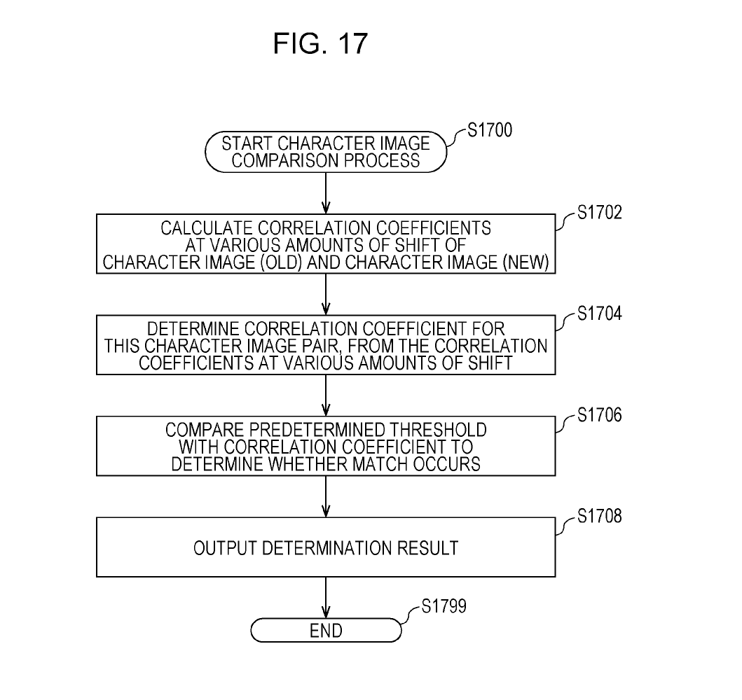

FIG. 17 is a flowchart illustrating an example of processing according to Exemplary Embodiment 2-3.

In step S1702, the correlation coefficient calculating module 1510 calculates correlation coefficients at various amounts of shift of the character image (old) 933A and the character image (new) 933B.

In step S1704, the correlation coefficient determining module 1520 determines the correlation coefficient for this character image pair, from among the correlation coefficients at various amounts of shift.

In step S1706, the match determining module 1530 compares a predetermined threshold with the correlation coefficient to determine whether the character images match.

In step S1708, the match determining module 1530 outputs the determination result.

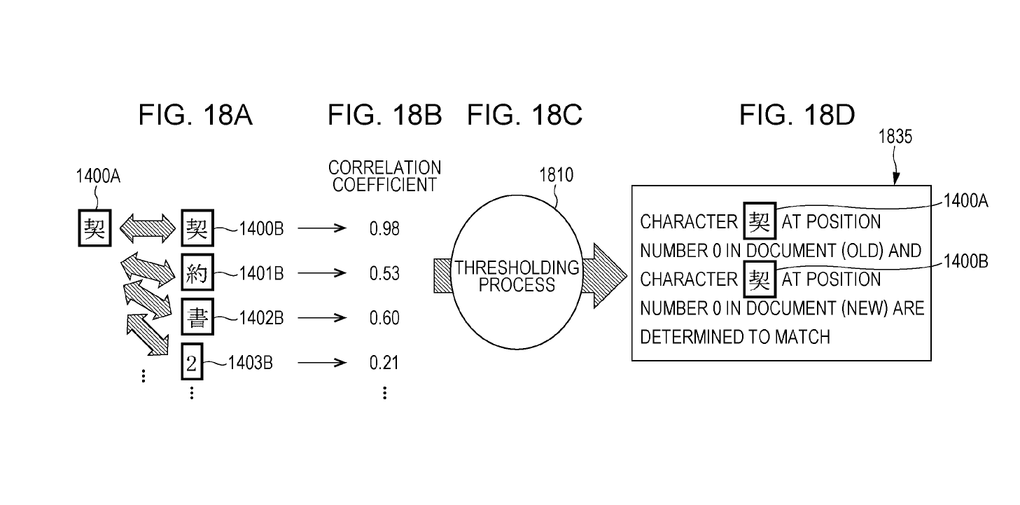

FIGS. 18A to 18D illustrate an example of processing according to Exemplary Embodiment 2-3.

As illustrated in the example of FIG. 15, correlation coefficients among character images are calculated (FIGS. 18A and 18B). Then, for example, with 0.83 set as a threshold, in a thresholding process 1810, it is determined whether there is any character image for which the correlation coefficient is greater than or equal to the threshold (FIG. 18C). If there is any character image for which the correlation coefficient is greater than or equal to the threshold, it is determined that a match occurs with the character. If there is no character image for which the correlation coefficient is greater than or equal to the threshold, it is determined that the character in question is a non-matching character. In the example of FIGS. 18A to 18D, a thresholding result 1835, which indicates that “the recognized character 1400A ( [symbol] ) at position number 0 in the document (old) and the recognized character 1400B ( [symbol] ) at position number 0 in the document (new) are determined to match”, is output (FIG. 18D).

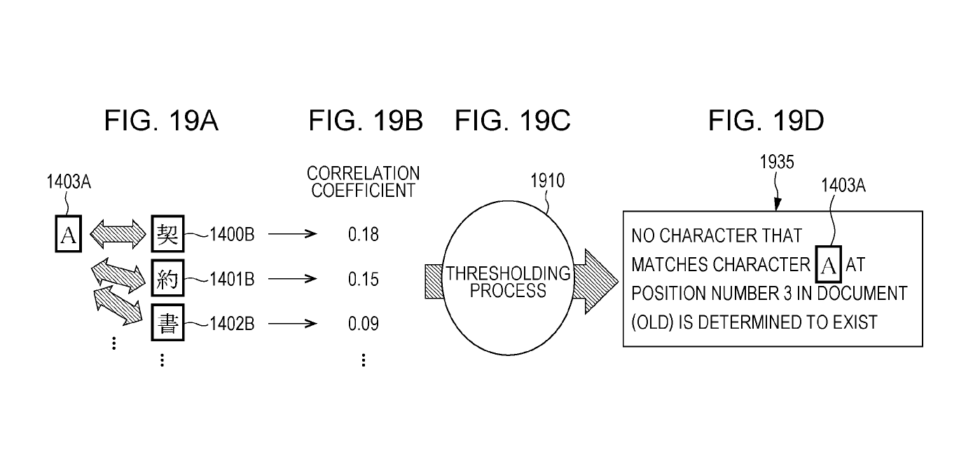

FIGS. 19A to 19D illustrate an example of processing according to Exemplary Embodiment 2-3.

As illustrated in the example of FIG. 15, correlation coefficients among character images are calculated (FIGS. 19A and 19B)). Then, for example, with 0.83 set as a threshold, in a thresholding process 1910, it is determined whether there is any character image for which the correlation coefficient is greater than or equal to the threshold (FIG. 19C). If there is any character image for which the correlation coefficient is greater than or equal to the threshold, it is determined that a match occurs with the character. If there is no character image for which the correlation coefficient is greater than or equal to the threshold, it is determined that the character in question is a non-matching character. In the example of FIGS. 19A to 19D, a thresholding result 1935, which indicates that “no character that matches a recognized character 1403A (A) at position number 3 in the document (old) is determined to exist”, is output (FIG. 19D).

### Exemplary Embodiment 2-4

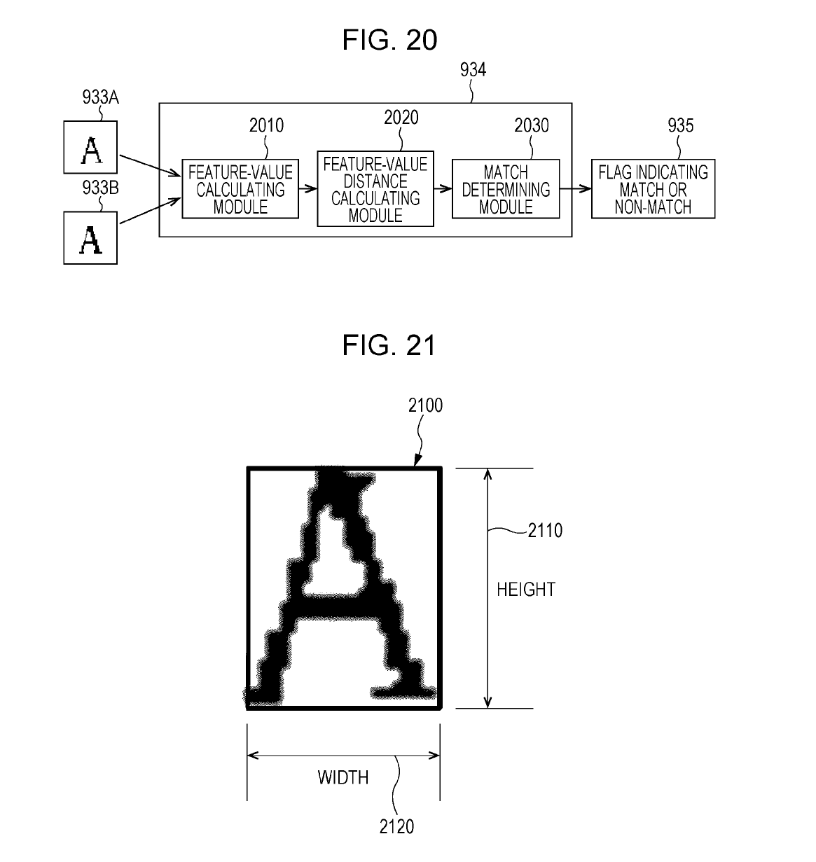

FIG. 20 is a conceptual module diagram of an example of configuration according to Exemplary Embodiment 2-4.

Exemplary Embodiment 2-4 represents a detailed configuration of modules within the character image comparing module 934 according to Exemplary Embodiment 2-2. The character image comparing module 934 has a feature-value calculating module 2010, a feature-value distance calculating module 2020, and a match determining module 2030.

The feature-value calculating module 2010 is connected to the feature-value distance calculating module 2020. The feature-value calculating module 2010 calculates the feature values of the character image (old) 933A in the image (old) 100A and the feature values of the character image (new) 933B in the image (new) 100B. For example, feature values such as the width, height, black pixel density, and projection histogram of each of the character images are calculated. In the example of FIG. 21, the feature values of a character image 2100 include a height 2110 and a width 2120.

The feature-value distance calculating module 2020 is connected to the feature-value calculating module 2010 and the match determining module 2030. The feature-value distance calculating module 2020 calculates the distance in the feature space between the character image (old) 933A in the image (old) 100A and the character image (new) 933B in the image (new) 100B.

For example, the feature-value distance calculating module 2020 sets a feature-value vector for the character image (old) 933A=(p₁, P₂, . . . , Pₙ), and a feature-value vector for the character image (new) 933B=(q₁, q₂, . . . , qₙ), where pᵢ and qᵢ represent each feature value (0<i≦n), and there are n feature values. Then, the distance D between feature values is calculated as follows.

Distance D between feature values=|p₁−q₁|²+|p₂−q₂|² + . . . |pₙ−qₙ|²

The match determining module 2030 is connected to the feature-value distance calculating module 2020. The match determining module 2030 compares the distance of feature values passed from the feature-value distance calculating module 2020 with a predetermined threshold, and determines that the character image (old) 933A and the character image (new) 933B match if “the distance between feature values is less than the threshold.” The character images are determined to be different if “the distance of feature values is greater than or equal to, or greater than, the threshold.”

Thereafter, the character-string-comparison-result modifying module 936 corrects a comparison result obtained by the character string comparing module 120, by using the flag indicative of match or non-match 935 passed from the match determining module 2030.

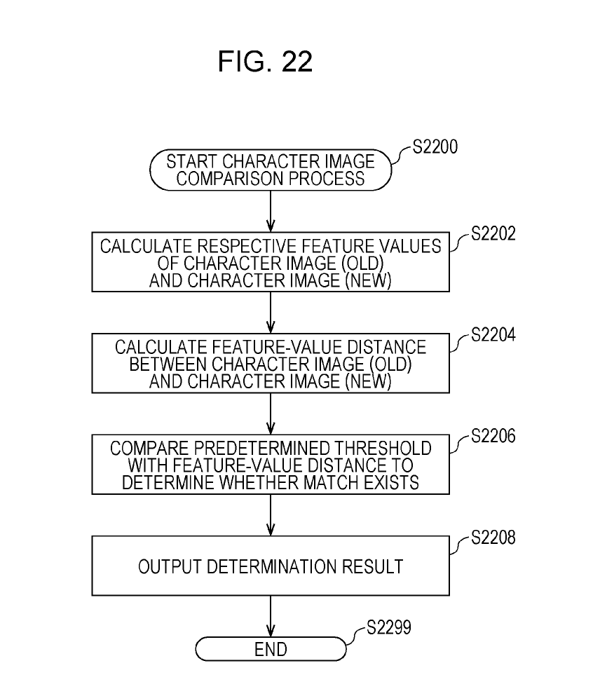

FIG. 22 is a flowchart illustrating an example of processing according to Exemplary Embodiment 2-4.

In step S2202, the feature-value calculating module 2010 calculates the respective feature values of the character image (old) 933A and the character image (new) 933B.

In step S2204, the feature-value distance calculating module 2020 calculates the feature-value distance between the character image (old) 933A and the character image (new) 933B.

In step S2206, the match determining module 2030 compares a predetermined threshold with the feature-value distance to determine whether the character images match.

In step S2208, the match determining module 2030 outputs the determination result.

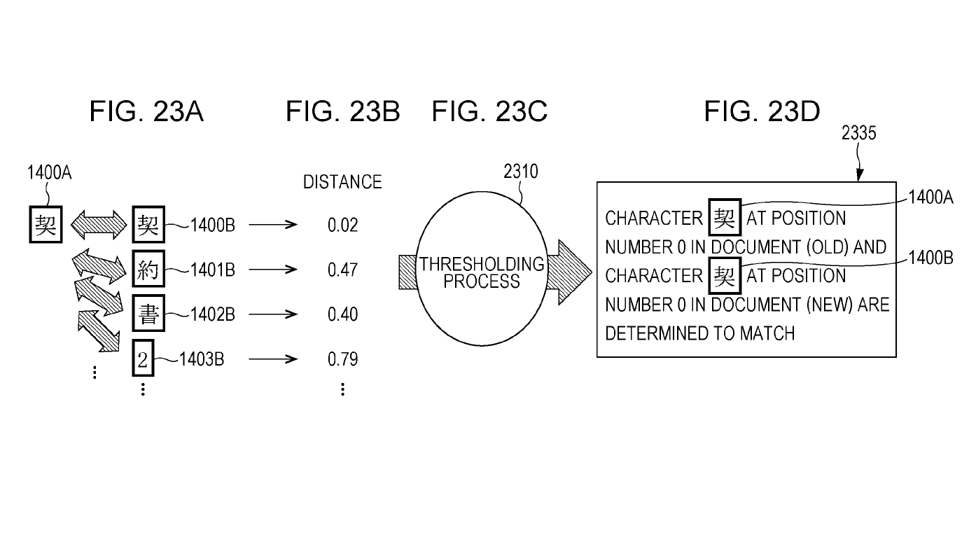

FIGS. 23A to 23D illustrate an example of processing according to Exemplary Embodiment 2-4.

As illustrated in the example of FIG. 20, the distances among the features of character images are calculated (FIGS. 23A and 23B). The feature values of each character image are calculated. For example, let the feature-value vector of the recognized character 1400A be (p₀₁, p₀₂, . . . , p₀ₙ). Let the feature-value vector of the recognized character 1400B or the like be (q₀₁, q₀₂, . . . , q₀ₙ). The distances D among the feature values of character images are calculated by the equation mentioned above. Then, for example, with 0.15 set as a threshold, in a thresholding process 2310, it is determined whether there is any character image for which the distance D is less than or equal to the threshold (FIG. 23C). If there is any character image for which the distance D is less than or equal to the threshold, it is determined that a match occurs with the character. If there is no character image for which the distance D is less than or equal to the threshold, it is determined that the character in question is a non-matching character. In the example of FIGS. 23A to 23D, a thresholding result 2335, which indicates that “the recognized character 1400A ( [symbol] ) at position number 0 in the document (old) and the recognized character 1400B ( [symbol] ) at position number 0 in the document (new) are determined to match”, is output (FIG. 23D).

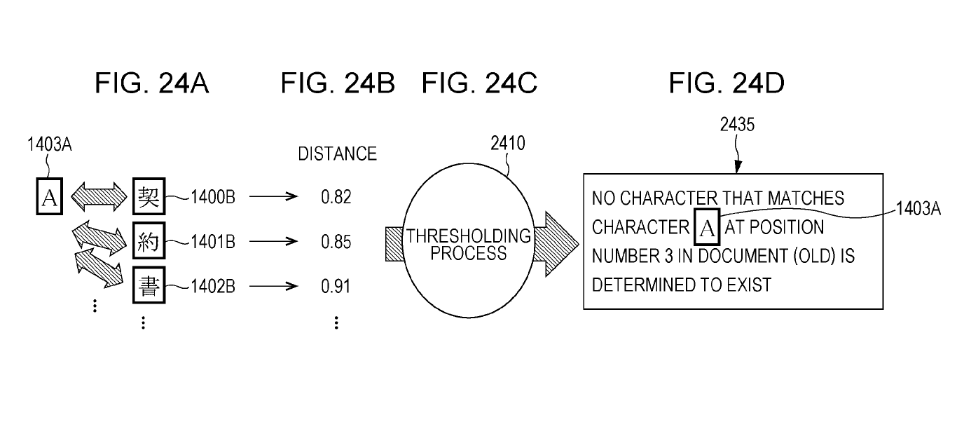

FIGS. 24A to 24D illustrate an example of processing according to Exemplary Embodiment 2-4.

As illustrated in the example of FIG. 20, the distances among the features of character images are calculated (FIGS. 24A and 24B). The feature values of each character image are calculated. For example, let the feature-value vector of the recognized character 1403A be (p₃₁, p₃₂, . . . , p₃ₙ). Let the feature-value vector of the recognized character 1400B or the like be (q₀₁, q₀₂, . . . q₀ₙ). The distances D among the feature values of character images are calculated by the equation mentioned above. Then, for example, with 0.15 set as a threshold, in a thresholding process 2410, it is determined whether there is any character image for which the distance D is less than or equal to the threshold (FIG. 24C). If there is any character image for which the distance D is less than or equal to the threshold, it is determined that a match occurs with the character. If there is no character image for which the distance D is less than or equal to the threshold, it is determined that the character in question is a non-matching character. In the example of FIGS. 24A to 24D, a thresholding result 2435, which indicates that “no character that matches the recognized character 1403A (A) at position number 3 in the document (old) is determined to exist”, is output (FIG. 24D).

### Exemplary Embodiment 2-5

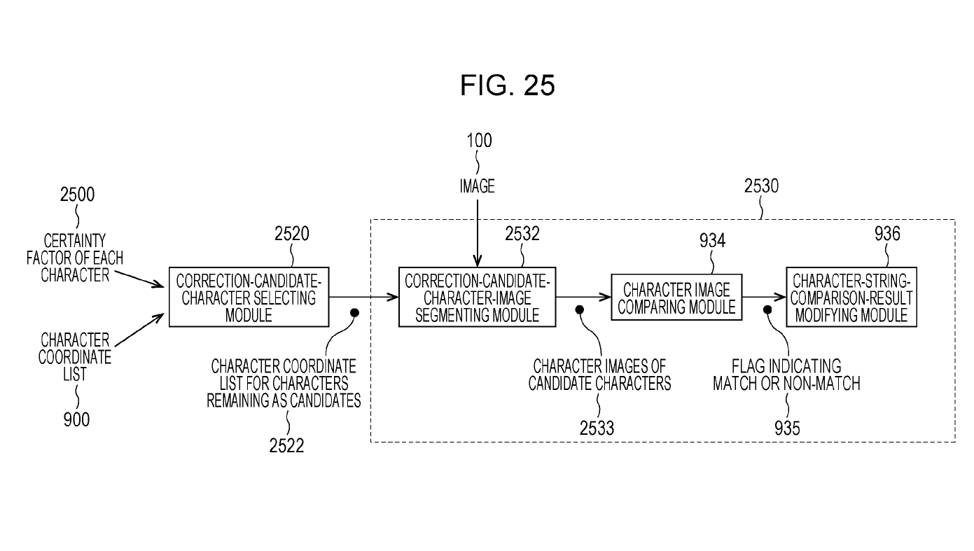

FIG. 25 is a conceptual module diagram of an example of configuration according to Exemplary Embodiment 2-5. In Exemplary Embodiment 2-5, a correction-candidate-character selecting module 2520 selects character images to be corrected, by using the certainty factor of the character recognition result. It is to be noted that a correction processing module 2530 corresponds to the correcting module 530 according to the above-mentioned exemplary embodiments (Exemplary Embodiment 2-1 to Exemplary Embodiment 2-4). That is, using the example of FIG. 5 for explanation, the correction-candidate-character selecting module 2520 exists between the character string comparing module 120 and the correcting module 530, and the correction processing module 2530 exists instead of the correcting module 530.

In the example of FIG. 25, the correction-candidate-character selecting module 2520 and the correction processing module 2530 are provided. The correction processing module 2530 has a correction-candidate-character-image segmenting module 2532, the character image comparing module 934, and the character-string-comparison-result modifying module 936.

The correction-candidate-character selecting module 2520 is connected to the correction-candidate-character-image segmenting module 2532. The correction-candidate-character selecting module 2520 compares the certainty factor for the recognition result obtained by the character recognizing module 110 with a predetermined value, and if the certainty factor is low, the correction-candidate-character selecting module 2520 selects the corresponding characters as characters to be corrected, also when the first character recognition result and the second character recognition result match. Then, a character coordinate list 2522 for candidate characters to be corrected is passed to the correction-candidate-character-image segmenting module 2532 within the correction processing module 2530. Specifically, the correction-candidate-character selecting module 2520 receives a certainty factor of each character 2500 (the certainty factor field 1234 of the character recognition result etc. table 1220 illustrated in the example of FIG. 12C) and the character coordinate list 900 from the character recognizing module 110, and if the certainty factor of each character 2500 is lower than or equal to, or lower than, a predetermined value, the correction-candidate-character selecting module 2520 generates the character coordinate list 2522 in such a way that a correction is to be performed also when, as a result of processing by the character string comparing module 120, the first character recognition result and the second character recognition result match.

Further, if the certainty factor of each character 2500 is lower than or equal to, or lower than, a predetermined value, deleted characters and inserted characters may be selected to be corrected. Accordingly, the character coordinate list 2522 may be generated in such a way that all of the characters in the character recognition result are to be corrected.

Further, the correction-candidate-character selecting module 2520 may compare the certainty factor for the recognition result obtained by the character recognizing module 110 with a predetermined value, and if the certainty factor is high, the correction-candidate-character selecting module 2520 does not select the corresponding characters as characters to be corrected if the first character recognition result and the second character recognition result match. Specifically, if the certainty factor of each character 2500 is higher than, or higher than or equal to, a predetermined value, and when the first character recognition result and the second character recognition result match, the correction-candidate-character selecting module 2520 does not include the corresponding characters in the character coordinate list 2522.

Further, the character coordinate list 2522 may be generated in such a way that if the certainty factor of each character 2500 is higher than, or higher than or equal to, a predetermined value, deleted characters, inserted characters, and replaced characters are selected to be corrected, and matching characters are not selected to be corrected.

The correction-candidate-character-image segmenting module 2532 is connected to the correction-candidate-character selecting module 2520 and the character image comparing module 934. While the correction-candidate-character-image segmenting module 2532 corresponds to the character image segmenting module 932 according to the above-mentioned exemplary embodiments, the character images to be segmented are those selected by the correction-candidate-character selecting module 2520. Specifically, character images are segmented out from the images 100 by using the character coordinate list 2522 passed from the correction-candidate-character selecting module 2520. Then, character images 2533 of candidate characters are passed to the character image comparing module 934.

The character image comparing module 934 is connected to the correction-candidate-character-image segmenting module 2532 and the character-string-comparison-result modifying module 936.

The character-string-comparison-result modifying module 936 is connected to the character image comparing module 934.

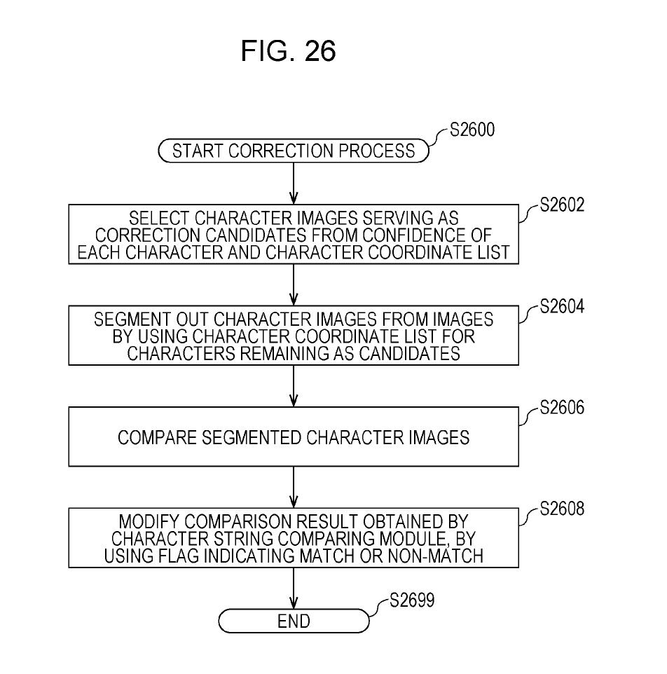

FIG. 26 is a flowchart illustrating an example of processing according to Exemplary Embodiment 2-5.

In step S2602, the correction-candidate-character selecting module 2520 selects character images serving as correction candidates from the certainty factor of each character 2500 and the character coordinate list 900.

In step S2604, the correction-candidate-character-image segmenting module 2532 segments out character images from the images 100 by using the character coordinate list 2522 of candidate characters.

In step S2606, the character image comparing module 934 compares the segmented character images 2533.

In step S2608, the character-string-comparison-result modifying module 936 modifies the comparison result 522 obtained by the character string comparing module 120, by the flag indicative of match or non-match 935.

### Exemplary Embodiment 2-6

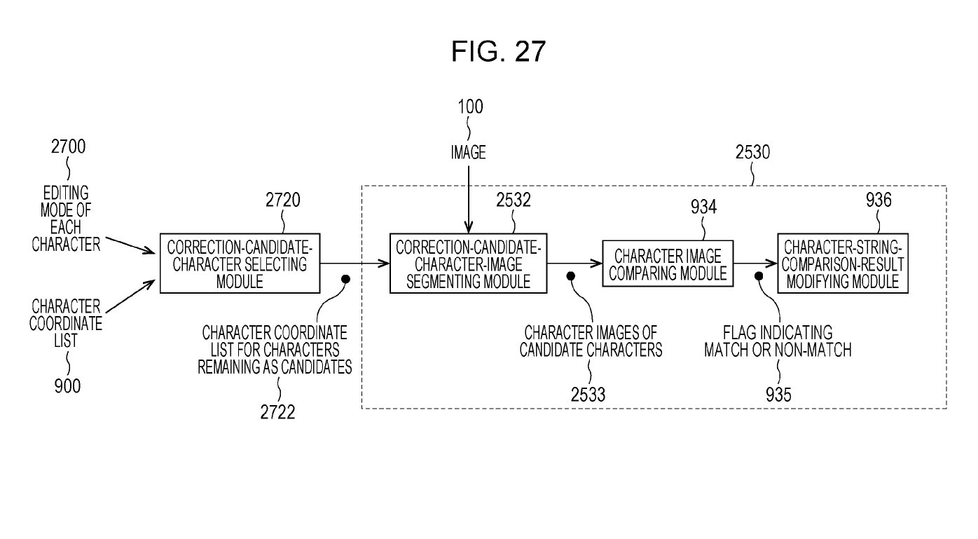

FIG. 27 is a conceptual module diagram of an example of configuration according to Exemplary Embodiment 2-6. In Exemplary Embodiment 2-6, a correction-candidate-character selecting module 2720 selects character images to be corrected, by using the editing mode of each character. Using the example of FIG. 5 for explanation, the correction-candidate-character selecting module 2720 exists between the character string comparing module 120 and the correcting module 530, and the correction processing module 2530 exists instead of the correcting module 530.

In the example of FIG. 27, the correction-candidate-character selecting module 2720 and the correction processing module 2530 are provided. The correction processing module 2530 has the correction-candidate-character-image segmenting module 2532, the character image comparing module 934, and the character-string-comparison-result modifying module 936.

The correction-candidate-character selecting module 2720 is connected to the correction-candidate-character-image segmenting module 2532. The correction-candidate-character selecting module 2720 selects characters in such a way that a comparison process (the process by the character image comparing module 934) is not performed for pairs of the character images of matching characters. Then, a character coordinate list 2722 for the selected characters is passed to the correction-candidate-character-image segmenting module 2532 within the correction processing module 2530. Specifically, the correction-candidate-character selecting module 2720 receives an editing mode of each character 2700 (the character string comparison result field 1192 of the comparison result table 1190 illustrated in the example of FIG. 11) from the character string comparing module 120, receives the character coordinate list 900 from the character recognizing module 110, and generates the character coordinate list 2722 representing characters obtained by excluding characters whose editing mode is “Match” from the character coordinate list 900. Accordingly, the correction-candidate-character selecting module 2720 generates the character coordinate list 2722 representing characters obtained by selecting characters whose editing modes are “Delete”, “Insert”, and “Replace” from the character coordinate list 900.

Further, the correction-candidate-character selecting module 2720 may perform a comparison process only for pairs of the character images of replaced characters. Specifically, the correction-candidate-character selecting module 2720 receives the editing mode of each character 2700 from the character string comparing module 120, receives the character coordinate list 900 from the character recognizing module 110, and generates the character coordinate list 2722 obtained by selecting only those characters whose editing mode is “Replace” from the character coordinate list 900.

The correction-candidate-character-image segmenting module 2532 is connected to the correction-candidate-character selecting module 2720 and the character image comparing module 934.

The character image comparing module 934 is connected to the correction-candidate-character-image segmenting module 2532 and the character-string-comparison-result modifying module 936.

The character-string-comparison-result modifying module 936 is connected to the character image comparing module 934.

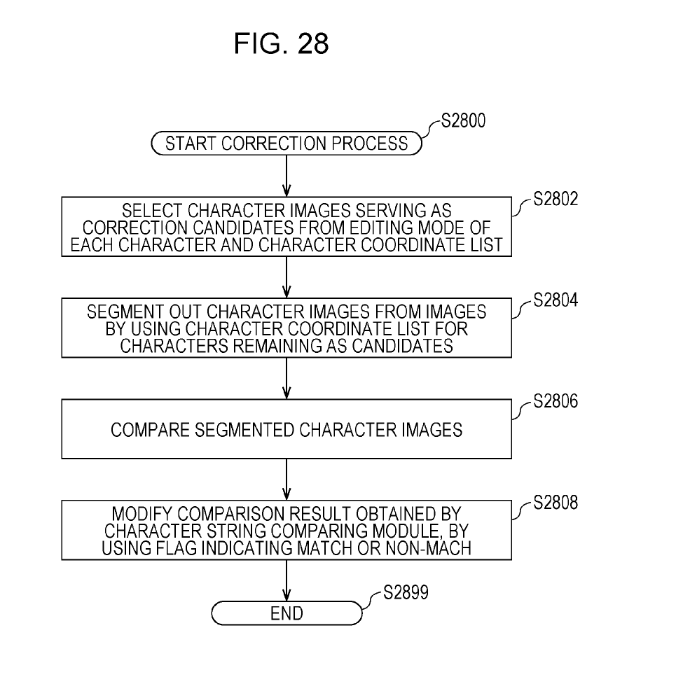

FIG. 28 is a flowchart illustrating an example of processing according to Exemplary Embodiment 2-6.

In step S2802, the correction-candidate-character selecting module 2720 selects character images serving as correction candidates from the editing mode of each character 2700 and the character coordinate list 900.

In step S2804, the correction-candidate-character-image segmenting module 2532 segments out character images from the images 100 by using the character coordinate list 2722 of candidate characters.

In step S2806, the character image comparing module 934 compares the segmented character images 2533.

In step S2808, the character-string-comparison-result modifying module 936 modifies the comparison result 522 obtained by the character string comparing module 120, by using the flag indicative of match or non-match 935.

It is to be understood that the various exemplary embodiments mentioned above may be combined (including, for example, adding a module in a given exemplary embodiment into another exemplary embodiment, and interchanging modules). Further, the techniques described in the background art section may be adopted for the processes to be performed by individual modules.

For example, Exemplary Embodiment 2-5 and Exemplary Embodiment 2-6may be combined as follows.

(1) Character images are selected to be compared so as to include at least a case in which the certainty factor is low as compared with a predetermined threshold, and the editing mode is “Replace.” In other cases, at least one of the followings or a combination thereof is adopted.

(2) If the certainty factor is high as compared with a predetermined threshold, and the editing mode is “Match”, the corresponding character images may not be selected to be compared.

(3) For enhanced precision, if the certainty factor is low, and the editing mode is either “Match”, “Delete”, or “Insert”, the corresponding character images may be selected to be compared.

(4) To achieve enhanced speed without compromising precision, if the certainty factor is high, and the editing mode is either “Match”, “Delete”, or “Insert”, the corresponding character images may not be selected to be compared.

The foregoing exemplary embodiments may be also understood as the following exemplary embodiment of the invention.

An image processing apparatus including a character recognizing unit that performs character recognition on a first image, and performs character recognition on a second image related to the first image, a determining unit that compares a first character recognition result of the first image obtained by the character recognizing unit, with a second character recognition result of the second image obtained by the character recognizing unit, to extract matching characters between the two character recognition results, and determines whether a character existing between the matching characters, which is obtained either as the first character recognition result or as the second character recognition result, is one of a character deleted from the first image, an inserted character that does not exist in the first image but exists in the second image, and a character by which a character in the first image has been replaced, and an outputting unit that outputs a determination result obtained by the determining unit.

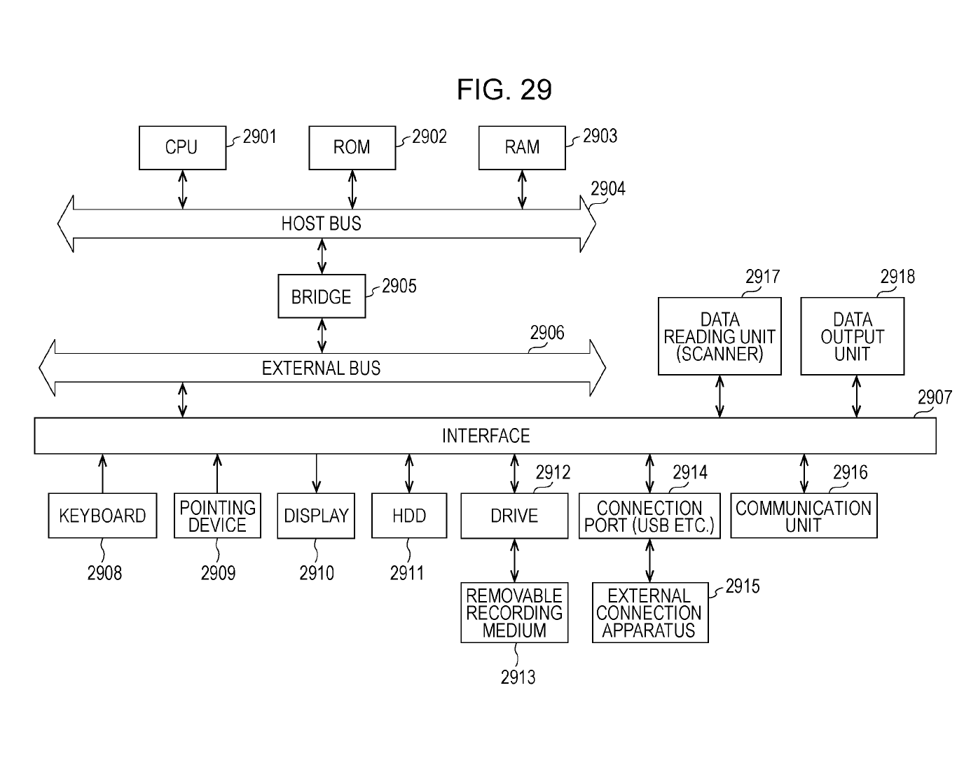

Referring to FIG. 29, an example of the hardware configuration of the image processing apparatus according to the exemplary embodiments will be described. The configuration illustrated in FIG. 29 is implemented by, for example, a personal computer (PC), and represents an example of hardware configuration including a data reading unit 2917 such as a scanner, and a data output unit 2918 such as a printer.

A central processing unit (CPU) 2901 is a controller that executes processes according to a computer program describing the execution sequence of various modules described above with reference to the foregoing exemplary embodiments, that is, modules such as the character recognizing module 110, the character string comparing module 120, the result outputting module 190, the correcting module 530, the character image segmenting module 932, the character image comparing module 934, the character-string-comparison-result modifying module 936, the correlation coefficient calculating module 1510, the correlation coefficient determining module 1520, the match determining module 1530, the feature-value calculating module 2010, the feature-value distance calculating module 2020, the match determining module 2030, the correction-candidate-character selecting module 2520, the correction processing module 2530, the correction-candidate-character-image segmenting module 2532, and the correction-candidate-character selecting module 2720.

A read only memory (ROM) 2902 stores programs, operation parameters, and the like used by the CPU 2901. A random access memory (RAM) 2903 stores programs used for execution by the CPU 2901, parameters that change as appropriate during execution of the programs, and the like. These components are interconnected via a host bus 2904, such as a CPU bus.

The host bus 2904 is connected to an external bus 2906, such as a peripheral component interconnect/interface (PCI) bus, via a bridge 2905.

A keyboard 2908 and a pointing device 2909 such as a mouse are input devices operated by an operator. A display 2910 is, for example, a liquid crystal display or a cathode ray tube (CRT), and displays various information as text or image information.

A hard disk drive (HDD) 2911, which has a built-in hard disk, drives the hard disk to record or reproduce programs to be executed by the CPU 2901 and information. The hard disk stores images to be compared, character images, character recognition results, correction results, and so on. The hard disk further stores various other computer programs such as various data processing programs.

A drive 2912 reads data or a program recorded on a removable recording medium 2913 loaded in the drive 2912, such as a magnetic disk, an optical disc, a magneto-optical disk, or a semiconductor memory, and supplies the data or program to the RAM 2903 that is connected via an interface 2907, the external bus 2906, the bridge 2905, and the host bus 2904. The removable recording medium 2913 may be also used as a data recording area similar to a hard disk.

A connection port 2914 is a port to which an external connection apparatus 2915 is to be connected. The connection port 2914 has a connection unit such as a USB or IEEE1394 connection unit. The connection port 2914 is connected to the CPU 2901 and the like via the interface 2907, the external bus 2906, the bridge 2905, the host bus 2904, and the like. A communication unit 2916, which is connected to a communication line, executes data communications with the outside. The data reading unit 2917 is, for example, a scanner, and executes a document reading process. The data output unit 2918 is, for example, a printer, and executes a document data output process.

The hardware configuration of the image processing apparatus depicted in FIG. 29 is only illustrative. The exemplary embodiments are not limited to the configuration illustrated in FIG. 29 as long as the modules described in the exemplary embodiments may be executed. For example, some modules may be implemented by dedicated hardware (such as an application-specific integrated circuit (ASIC)), and some modules may be provided within an external system and may be connected via a communication line. Further, multiple systems configured as illustrated in FIG. 29 may be connected to each another by a communication line so as to operate in cooperation with each other. Further, the above configuration may be incorporated in, for example, copiers, facsimiles, scanners, printers, and multifunction machines (image processing apparatuses having two or more of, for example, scanner, printer, copier, and facsimile functions).

The program described herein may be provided in the form of being stored on a recording medium, or the program may be provided via a communication unit. In that case, for example, the above-mentioned program may be understood as an invention relating to a “computer readable recording medium recording a program.”

The “computer readable recording medium recording a program” refers to a computer readable recording medium on which a program is recorded and which is used for purposes such as installing, executing, and distributing the program.

Examples of the recording medium include digital versatile discs (DVDs), such as “DVD-R, DVD-RW, DVD-RAM, and the like”, which are standards developed by the DVD Forum, and “DVD+R, DVD+RW, and the like”, which are standards developed by the DVD Forum, compact discs (CDs) such as read-only memory (CD-ROM), CD-Recordable (CD-R), and CD-Rewritable (CD-RW) discs, Blu-ray Discs (registered trademark)), magneto-optical disks (MOs), flexible disks (FDs), magnetic tapes, hard disks, read-only memories (ROMs), electrically erasable programmable read-only memories (EEPROMs (registered trademark)), flash memories, random access memories (RAMs), and Secure Digital (SD) memory cards.

The above-mentioned program or a portion thereof may be recorded on the above-mentioned recording medium for purposes such as saving and distribution. Alternatively, the program may be transmitted via a transmission medium such as a wired network or a wireless communication network which is used for a local area network (LAN), a metropolitan area network (MAN), a wide area network (WAN), the Internet, an intranet, an extranet, and the like, or a combination thereof, or may be carried on a carrier wave.

Further, the program mentioned above may be part of another program, or may be recorded on a recording medium together with a different program. Alternatively, the program may be recorded separately on multiple recording media. Furthermore, the program may be recorded in any form, such as compressed or encrypted, as long as the program may be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a character recognizing unit that performs character recognition on a first image, and performs character recognition on a second image related to the first image;
a comparing unit that compares a first character recognition result of the first image obtained by the character recognizing unit, with a second character recognition result of the second image obtained by the character recognizing unit;
a determining unit that extracts matching characters between the two character recognition results, and determines whether a character existing between the matching characters, which is obtained either as the first character recognition result or as the second character recognition result, is one of a character deleted from the first image, an inserted character that does not exist in the first image but exists in the second image, and a character by which a character in the first image has been replaced; and
an outputting unit that outputs a comparison result obtained by the comparing unit.

2. The image processing apparatus according to claim 1, further comprising:
a correcting unit that corrects the comparison result obtained by the comparing unit, by making a comparison between corresponding characters in the first image and the second image,
wherein the outputting unit outputs the comparison result corrected by the correcting unit.

3. The image processing apparatus according to claim 2, wherein the correcting unit calculates a correlation coefficient between a character image in the first image and a character image in the second image, and corrects the comparison result obtained by the comparing unit based on the correlation coefficient.

4. The image processing apparatus according to claim 2, wherein the correcting unit calculates a distance in a feature space between a character image in the first image and a character image in the second image, and corrects the comparison result obtained by the comparing unit based on the distance.

5. The image processing apparatus according to claim 2, wherein the correcting unit compares a certainty factor for a recognition result obtained by the character recognizing unit, with a predetermined value, and if the certainty factor is lower than, or lower than or equal to, the predetermined value, the correcting unit further performs correction when the first character recognition result matches the second character recognition result.

6. The image processing apparatus according to claim 2, wherein the correcting unit compares a certainty factor for a recognition result obtained by the character recognizing unit, with a predetermined value, and if the certainty factor is higher than, or higher than or equal to, the predetermined value, the correcting unit does not perform correction when the first character recognition result matches the second character recognition result.

7. The image processing apparatus according to claim 2, wherein the correcting unit does not perform the comparison for character images of the matching characters.

8. The image processing apparatus according to claim 2, wherein:
the comparing unit extracts replaced characters by comparing the first character recognition result with the second character recognition result; and
the correcting unit performs the comparison only for character images of the replaced characters.

9. A non-transitory computer readable medium storing a program causing a computer to execute a process for processing an image, the process comprising:
performing character recognition on a first image, and performing character recognition on a second image related to the first image;
comparing a first character recognition result of the first image recognized by the character recognition, with a second character recognition result of the second image recognized by the character recognition;
extracting matching characters between the two character recognition results, and determining whether a character existing between the matching characters, which is obtained either as the first character recognition result or as the second character recognition result, is one of a character deleted from the first image, an inserted character that does not exist in the first image but exists in the second image, and a character by which a character in the first image has been replaced; and
outputting a comparison result obtained by the comparing.

10. A non-transitory computer readable medium storing a program causing a computer to execute a process for processing an image, the process comprising:
performing character recognition on a first image, and performing character recognition on a second image related to the first image;
comparing a first character recognition result of the first image recognized by the character recognition, with a second character recognition result of the second image recognized by the character recognition, to extract matching characters between the two character recognition results, and determining whether a character existing between the matching characters, which is obtained either as the first character recognition result or as the second character recognition result, is one of a character deleted from the first image, an inserted character that does not exist in the first image but exists in the second image, and a character by which a character in the first image has been replaced; and
outputting a determination result obtained by the determining.

11. An image processing method comprising:
performing character recognition on a first image, and performing character recognition on a second image related to the first image;
comparing a first character recognition result of the first image recognized by the character recognition, with a second character recognition result of the second image recognized by the character recognition;
extracting matching characters between the two character recognition results, and determining whether a character existing between the matching characters, which is obtained either as the first character recognition result or as the second character recognition result, is one of a character deleted from the first image, an inserted character that does not exist in the first image but exists in the second image, and a character by which a character in the first image has been replaced; and
outputting a comparison result obtained by the comparing.
